(19) United States
(12) Patent Application Publication
(10) Pub. No.: US 2022/0032601 A1
(43) Pub. Date: Feb. 3, 2022

(54) GLASS PROCESSING APPARATUS AND METHODS

(71) Applicant: CORNING INCORPORATED, CORNING, NY (US)

(72) Inventor: Akihiro Ohtsubo, Sakai-City (JP)

(21) Appl. No.: 17/299,160

(22) PCT Filed: Nov. 25, 2019
(86) PCT No.: PCT/US2019/062919

§ 371 Date: Jun. 2, 2021

Related U.S. Application Data
(60) Provisional application No. 62/776,164, filed on Dec. 6, 2018.

(51) Int. Cl. B32B 43/00; B32B 17/10; B32B 17/08

(52) U.S. Cl. CPC B32B 43/006; B32B 17/10; B32B 2317/18; B32B 2315/08; B32B 17/08

(57) ABSTRACT

A glass processing apparatus can comprise a first suction device positioned to receive one or more of a first protective layer or a second protective layer. The glass processing apparatus can further comprise a diverting apparatus positioned to receive the first and second protective layer. The diverting apparatus may be movable to direct the first protective layer along a first travel path and the second protective layer along a second travel path. The glass processing apparatus can further comprise a first processing apparatus positioned to receive the first protective layer and produce a first processed product from the first protective layer. The glass processing apparatus can also comprise a second processing apparatus positioned to receive the second protective layer and produce a second processed product different than the first processed product, from the second protective layer. In some embodiments, methods for processing glass with a glass processing apparatus.

### CROSS-REFERENCE TO RELATED APPLICATIONS

This application claims the benefit of priority of U.S. Provisional Application Ser. No. 62/776,164 filed on Dec. 6, 2018 the contents of which are relied upon and incorporated herein by reference in their entirety as if fully set forth below.

### FIELD

The present disclosure relates generally to methods for processing glass and, more particularly, to methods for processing glass with a glass processing apparatus comprising one or more suction devices.

### BACKGROUND

It is known to collect and process a protective layer that protects a major surface of a glass ribbon. One way to collect the protective layer comprises manual collection. However, depending on the type of material of the protective layer, different collection methods have been implemented. Using different collection methods, some of which comprise manual collection of the protective layers, may be costly and inefficient.

### SUMMARY

The following presents a simplified summary of the disclosure to provide a basic understanding of some embodiments described in the detailed description.

In accordance with some embodiments, a glass processing apparatus can comprise a first suction device positioned to receive one or more of a first protective layer from a first glass ribbon or a second protective layer from one or more of the first glass ribbon or a second glass ribbon. The second protective layer is different than the first protective layer. The glass processing apparatus can comprise a diverting apparatus positioned to receive the first protective layer and the second protective layer. The diverting apparatus is movable to direct the first protective layer along a first travel path and the second protective layer along a second travel path. The glass processing apparatus can comprise a first processing apparatus positioned to receive the first protective layer from the diverting apparatus and produce a first processed product from the first protective layer. The glass processing apparatus can comprise a second processing apparatus positioned to receive the second protective layer from the diverting apparatus and produce a second processed product different than the first processed product, from the second protective layer.

In some embodiments, the glass processing apparatus can further comprise a second suction device positioned to receive from one or more of the first glass ribbon or the second glass ribbon the second protective layer.

In some embodiments, the glass processing apparatus can further comprise a blower positioned to blow the first protective layer away from the first glass ribbon and toward the first suction device along a first blow path.

In some embodiments, the first glass ribbon can further comprise a separated glass ribbon.

In some embodiments, the glass processing apparatus can further comprise a sensor positioned to detect a presence of one or more of the first protective layer within the first suction device or the second protective layer within the second suction device.

In some embodiments, the glass processing apparatus can further comprise a cutting device positioned to receive the first protective layer from the diverting apparatus and cut the first protective layer.

In some embodiments, the first processing apparatus can comprise a screw feeder and a melter, and the first processed product comprises one or more melted portions.

In some embodiments, the second processing apparatus can comprise a compressor.

In some embodiments, the first protective layer can comprise a polymeric material.

In some embodiments, the second protective layer can comprise a cellulose material.

In accordance with some embodiments, methods of processing glass with a glass processing apparatus can comprise receiving a first protective layer within a first suction device. Methods can further comprise receiving a second protective layer within a second suction device. Methods can further comprise directing the first protective layer from the first suction device to a diverting apparatus and the second protective layer from the second suction device to the diverting apparatus. Methods can further comprise diverting the first protective layer from the diverting apparatus to a first processing apparatus. Methods can further comprise diverting the second protective layer from the diverting apparatus to a second processing apparatus.

In some embodiments, methods can further comprise melting the first protective layer and forming a plurality of melted portions from the melted first protective layer.

In some embodiments, methods can further comprise compressing the second protective layer.

In some embodiments, methods can further comprise blowing the first protective layer away from a first glass ribbon to the first suction device along a first blow path.

In some embodiments, the diverting the first protective layer from the diverting apparatus can comprise cutting the first protective layer.

In some embodiments, methods can further comprise detecting a presence of one or more of the first protective layer within the first suction device or the second protective layer within the second suction device.

In accordance with some embodiments, methods of processing glass with a glass processing apparatus can comprise positioning a first glass ribbon within a first blow path between a blower and a first suction device. Methods can further comprise blowing a first protective layer with the blower away from the first glass ribbon along the first blow path. Methods can further comprise receiving the first protective layer within the first suction device. Methods can further comprise cutting the first protective layer to produce a cut material. Methods can further comprise directing the cut material to a first processing apparatus. Methods can further comprise producing a first processed product from the cut material.

In some embodiments, the producing the first processed product can comprise melting the cut material and forming a plurality of melted portions from the melted cut material.

In some embodiments, methods can further comprise detecting the receiving of the first protective layer within the first suction device.

In some embodiments, methods can further comprise rotating the blower to adjust the blower for a position of the first glass ribbon relative to the first suction device.

### BRIEF DESCRIPTION OF THE DRAWINGS

These and other features, embodiments and advantages are better understood when the following detailed description is read with reference to the accompanying drawings, in which:

FIG. 1 schematically illustrates a glass manufacturing apparatus in accordance with embodiments of the disclosure;

FIG. 2 shows a perspective cross-sectional view of the glass manufacturing apparatus along line 2-2 of FIG. 1 in accordance with embodiments of the disclosure;

FIG. 3 schematically illustrates example embodiments of methods of processing glass in which a first glass ribbon lies outside of a first blow path in accordance with embodiments of the disclosure;

FIG. 4 schematically illustrates example embodiments of methods of processing glass in which the first glass ribbon lies within the first blow path in accordance with embodiments of the disclosure;

FIG. 5 schematically illustrates example embodiments of methods of processing glass in which a first protective layer can be blown into a first suction device in accordance with embodiments of the disclosure;

FIG. 6 schematically illustrates example embodiments of methods of processing glass in which a second protective layer can be received within a second suction device in accordance with embodiments of the disclosure;

FIG. 7 schematically illustrates example embodiments of methods of processing glass in which the first protective layer can be directed to a first processing apparatus and the second protective layer can be directed to a second processing apparatus in accordance with embodiments of the disclosure;

FIG. 8 illustrates a schematic top view of example embodiments of methods of processing glass in which a blower rotates to accommodate for a position of the first glass ribbon relative to the first suction device in accordance with embodiments of the disclosure; and

FIG. 9 schematically illustrates example embodiments of methods of processing glass in which a first protective layer and a second protective layer can be blown into a first suction device in accordance with embodiments of the disclosure.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

The present disclosure relates to a glass manufacturing apparatus and methods for manufacturing a glass article (e.g., a glass ribbon) from a quantity of molten material. A slot draw apparatus, float bath apparatus, down-draw apparatus, up-draw apparatus, press-rolling apparatus or other glass manufacturing apparatus can be used to form a glass ribbon from a quantity of molten material.

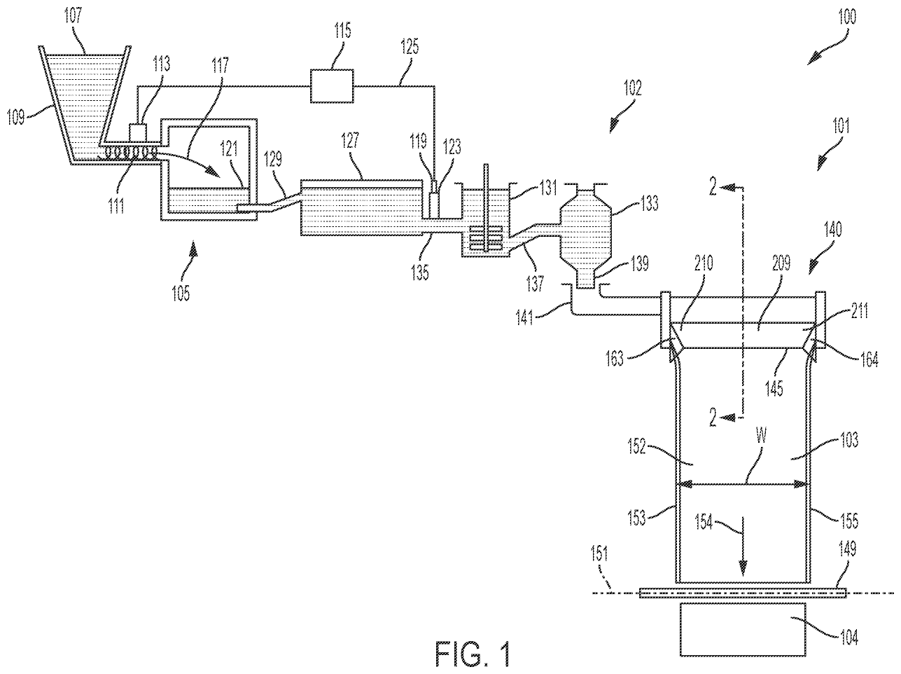

Methods and apparatus for manufacturing glass will now be described by way of example embodiments for forming a glass ribbon from a quantity of molten material. As schematically illustrated in FIG. 1, in some embodiments, an example glass manufacturing apparatus 100 can comprise a glass melting and delivery apparatus 102 and a forming apparatus 101 comprising a forming vessel 140 designed to produce a glass ribbon 103 from a quantity of molten material 121. In some embodiments, the glass ribbon 103 can comprise a central portion 152 positioned between opposite, thick edge portions (e.g., “beads”) formed along a first outer edge 153 and a second outer edge 155 of the glass ribbon 103. Additionally, in some embodiments, a separated glass ribbon 104 can be separated from the glass ribbon 103 along a separation path 151 by a glass separator 149 (e.g., scribe, score wheel, diamond tip, laser, etc.). In some embodiments, before or after separation of the separated glass ribbon 104 from the glass ribbon 103, the thick edge beads formed along the first outer edge 153 and the second outer edge 155 can be removed to provide the central portion 152 as a high-quality separated glass ribbon 104 with a uniform thickness.

In some embodiments, the glass melting and delivery apparatus 102 can comprise a melting vessel 105 oriented to receive batch material 107 from a storage bin 109. The batch material 107 can be introduced by a batch delivery device 111 powered by a motor 113. In some embodiments, an optional controller 115 can be operated to activate the motor 113 to introduce a desired amount of batch material 107 into the melting vessel 105, as indicated by arrow 117. The melting vessel 105 can heat the batch material 107 to provide molten material 121. In some embodiments, a melt probe 119 can be employed to measure a level of molten material 121 within a standpipe 123 and communicate the measured information to the controller 115 by way of a communication line 125.

Additionally, in some embodiments, the glass melting and delivery apparatus 102 can comprise a first conditioning station comprising a fining vessel 127 located downstream from the melting vessel 105 and coupled to the melting vessel 105 by way of a first connecting conduit 129. In some embodiments, molten material 121 can be gravity fed from the melting vessel 105 to the fining vessel 127 by way of the first connecting conduit 129. For example, in some embodiments, gravity can drive the molten material 121 through an interior pathway of the first connecting conduit 129 from the melting vessel 105 to the fining vessel 127. Additionally, in some embodiments, bubbles can be removed from the molten material 121 within the fining vessel 127 by various techniques.

In some embodiments, the glass melting and delivery apparatus 102 can further comprise a second conditioning station comprising a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In some embodiments, molten material 121 can be gravity fed from the fining vessel 127 to the mixing chamber 131 by way of the second connecting conduit 135. For example, in some embodiments, gravity can drive the molten material 121 through an interior pathway of the second connecting conduit 135 from the fining vessel 127 to the mixing chamber 131.

Additionally, in some embodiments, the glass melting and delivery apparatus 102 can comprise a third conditioning station comprising a delivery vessel 133 that can be located downstream from the mixing chamber 131. In some embodiments, the delivery vessel 133 can condition the molten material 121 to be fed into an inlet conduit 141. For example, the delivery vessel 133 can function as an accumulator and/or flow controller to adjust and provide a consistent flow of molten material 121 to the inlet conduit 141. As shown, the mixing chamber 131 can be coupled to the delivery vessel 133 by way of a third connecting conduit 137. In some embodiments, molten material 121 can be gravity fed from the mixing chamber 131 to the delivery vessel 133 by way of the third connecting conduit 137. For example, in some embodiments, gravity can drive the molten material 121 through an interior pathway of the third connecting conduit 137 from the mixing chamber 131 to the delivery vessel 133. As further illustrated, in some embodiments, a delivery pipe 139 can be positioned to deliver molten material 121 to forming apparatus 101, for example the inlet conduit 141 of the forming vessel 140.

Forming apparatus 101 can comprise various embodiments of forming vessels in accordance with features of the disclosure comprising a forming vessel with a wedge for fusion drawing the glass ribbon, a forming vessel with a slot to slot draw the glass ribbon, or a forming vessel provided with press rolls to press roll the glass ribbon from the forming vessel. By way of illustration, the forming vessel 140 shown and disclosed below can be provided to fusion draw molten material 121 off a bottom edge, defined as a root 145, of a forming wedge 209 to produce a ribbon of molten material 121 that can be drawn and cooled into the glass ribbon 103. For example, in some embodiments, the molten material 121 can be delivered from the inlet conduit 141 to the forming vessel 140. The molten material 121 can then be formed into the glass ribbon 103 based, in part, on the structure of the forming vessel 140. For example, as shown, the molten material 121 can be drawn as a ribbon of molten material off the bottom edge (e.g., root 145) of the forming vessel 140 along a draw path extending in a draw direction 154 of the glass manufacturing apparatus 100. In some embodiments, edge directors 163, 164 can direct the ribbon of molten material off the forming vessel 140 and define, in part, a width “W” of the glass ribbon 103. In some embodiments, the width “W” of the glass ribbon 103 can extend between the first outer edge 153 of the glass ribbon 103 and the second outer edge 155 of the glass ribbon 103.

In some embodiments, the width “W” of the glass ribbon 103, which is the dimension between the first outer edge 153 of the glass ribbon 103 and the second outer edge 155 of the glass ribbon 103 in a direction that is orthogonal to the draw direction 154, can be greater than or equal to about 20 mm, such as greater than or equal to about 50 mm, such as greater than or equal to about 100 mm, such as greater than or equal to about 500 mm, such as greater than or equal to about 1000 mm, such as greater than or equal to about 2000 mm, such as greater than or equal to about 3000 mm, such as greater than or equal to about 4000 mm, although other widths less than or greater than the widths mentioned above can be provided in further embodiments. For example, in some embodiments, the width “W” of the glass ribbon 103 can be from about 20 mm to about 4000 mm, such as from about 50 mm to about 4000 mm, such as from about 100 mm to about 4000 mm, such as from about 500 mm to about 4000 mm, such as from about 1000 mm to about 4000 mm, such as from about 2000 mm to about 4000 mm, such as from about 3000 mm to about 4000 mm, such as from about 20 mm to about 3000 mm, such as from about 50 mm to about 3000 mm, such as from about 100 mm to about 3000 mm, such as from about 500 mm to about 3000 mm, such as from about 1000 mm to about 3000 mm, such as from about 2000 mm to about 3000 mm, such as from about 2000 mm to about 2500 mm, and all ranges and subranges therebetween.

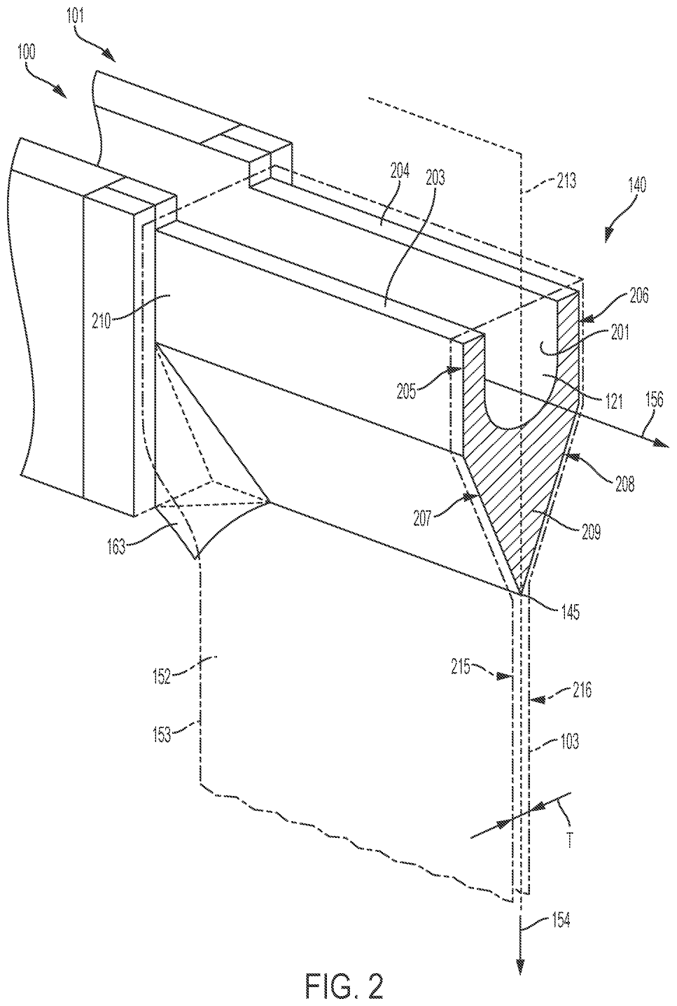

FIG. 2 shows a cross-sectional perspective view of the forming apparatus 101 (e.g., forming vessel 140) along line 2-2 of FIG. 1. In some embodiments, the forming vessel 140 can comprise a trough 201 oriented to receive the molten material 121 from the inlet conduit 141. For illustrative purposes, cross-hatching of the molten material 121 is removed from FIG. 2 for clarity. The forming vessel 140 can further comprise the forming wedge 209 comprising a pair of downwardly inclined converging surface portions 207, 208 extending between opposed ends 210, 211 (See FIG. 1) of the forming wedge 209. The pair of downwardly inclined converging surface portions 207, 208 of the forming wedge 209 can converge along the draw direction 154 to intersect along the root 145 of the forming vessel 140. A draw plane 213 of the glass manufacturing apparatus 100 can extend through the root 145 along the draw direction 154. In some embodiments, the glass ribbon 103 can be drawn in the draw direction 154 along the draw plane 213. As shown, the draw plane 213 can bisect the forming wedge 209 through the root 145 although, in some embodiments, the draw plane 213 can extend at other orientations relative to the root 145.

Additionally, in some embodiments, the molten material 121 can flow in a direction 156 into and along the trough 201 of the forming vessel 140. The molten material 121 can then overflow from the trough 201 by simultaneously flowing over corresponding weirs 203, 204 and downward over the outer surfaces 205, 206 of the corresponding weirs 203, 204. Respective streams of molten material 121 can then flow along the downwardly inclined converging surface portions 207, 208 of the forming wedge 209 to be drawn off the root 145 of the forming vessel 140, where the flows converge and fuse into the ribbon of molten material. The ribbon of molten material can then be drawn off the root 145 in the draw plane 213 along the draw direction 154 and cooled into the glass ribbon 103.

The glass ribbon 103 comprises a first major surface 215 and a second major surface 216 facing opposite directions and defining a thickness “T” (e.g., average thickness) of the glass ribbon 103. In some embodiments, the thickness “T” (e.g., average thickness) of the glass ribbon 103 can be less than or equal to about 2 millimeters (mm), less than or equal to about 1 millimeter, less than or equal to about 0.5 millimeters, for example, less than or equal to about 300 micrometers (μm), less than or equal to about 200 micrometers, or less than or equal to about 100 micrometers, although other thicknesses may be provided in further embodiments. For example, in some embodiments, the thickness “T” of the glass ribbon 103 can be from about 50 μm to about 750 μm, from about 100 μm to about 700 μm, from about 200 μm to about 600 μm, from about 300 μm to about 500 μm, from about 50 μm to about 500 μm, from about 50 μm to about 700 μm, from about 50 μm to about 600 μm, from about 50 μm to about 500 μm, from about 50 μm to about 400 μm, from about 50 μm to about 300 μm, from about 50 μm to about 200 μm, from about 50 μm to about 100 μm, comprising all ranges and subranges of thicknesses therebetween. In addition, the glass ribbon 103 can comprise a variety of compositions comprising, but not limited to, soda-lime glass, borosilicate glass, alumino-borosilicate glass, alkali-containing glass, or alkali-free glass.

In some embodiments, the glass separator 149 (see FIG. 1) can then separate a separated glass ribbon 104 from the glass ribbon 103 along the separation path 151 as the glass ribbon 103 is formed by the forming vessel 140. As illustrated, in some embodiments, the separation path 151 can extend along the width “W” of the glass ribbon 103 between the first outer edge 153 and the second outer edge 155, such as by being orthogonal to the draw direction 154. Moreover, in some embodiments, the draw direction 154 can define a direction along which the glass ribbon 103 can be drawn from the forming vessel 140.

In some embodiments, a plurality of separated glass ribbons 104 can be stacked to form a stack of separated glass ribbons 104. In some embodiments, interleaf material can be placed between an adjacent pair of separated glass ribbons 104 to help prevent contact and therefore preserve the pristine surfaces of the pair of separated glass ribbons 104.

In further embodiments, although not shown, glass ribbon 103 from the glass manufacturing apparatus may be coiled onto a storage roll. Once a desired length of coiled glass ribbon is stored on the storage roll, the glass ribbon 103 may be separated by the glass separator 149 such that the separated glass ribbon is stored on the storage roll. In further embodiments, a separated glass ribbon can be separated into another separated glass ribbon. For example, a separated glass ribbon 104 (e.g., from the stack of glass ribbons) can be further separated into another separated glass ribbon. In further embodiments, a separated glass ribbon stored on a storage roll can be uncoiled and further separated into another separated glass ribbon.

The separated glass ribbon can then be processed into a desired application, e.g., a display application. For example, the separated glass ribbon can be used in a wide range of display applications, comprising liquid crystal displays (LCDs), electrophoretic displays (EPD), organic light emitting diode displays (OLEDs), plasma display panels (PDPs), and other electronic displays.

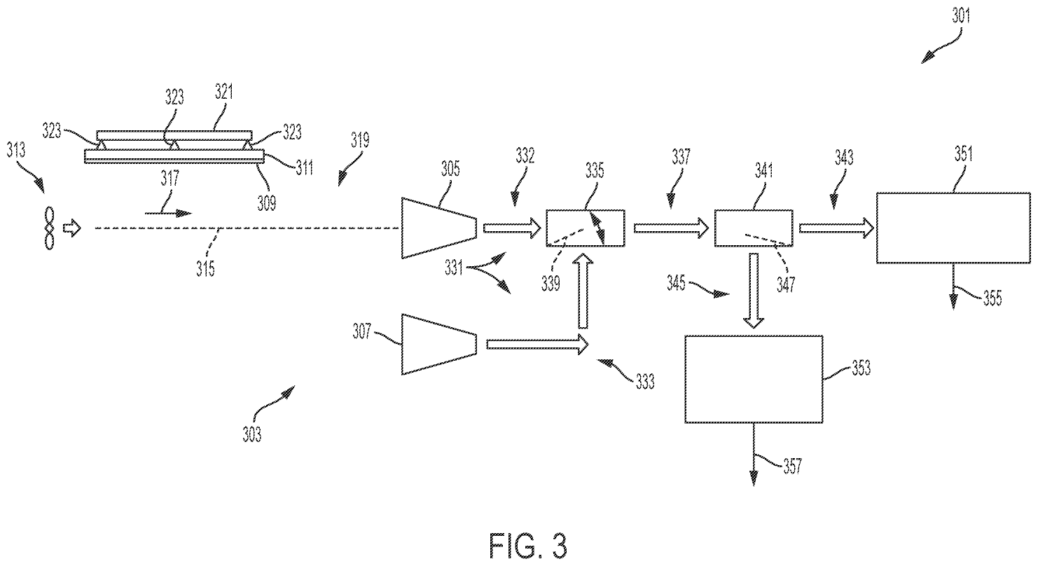

FIG. 3 illustrates a schematic top view of a glass processing apparatus 301, according to some embodiments. In some embodiments, the glass processing apparatus 301 is positioned downstream from the forming apparatus 101. As such, in some embodiments, the glass processing apparatus 301 may be provided as a downstream processing station of the glass manufacturing apparatus 100 that is positioned downstream from the glass forming apparatus 101 that produces the separated glass ribbon 104. In alternative embodiments, the glass processing apparatus 301 may treat separated glass ribbon 104 offsite. For example, a stack of separated glass ribbon 104 may be fed into the glass processing apparatus 301 at a processing location (e.g., remote from the glass manufacturing apparatus 100) where further processing of the separated glass ribbon 104 is carried out. In further embodiments, a storage roll of glass ribbon may be uncoiled and separated into glass ribbon 104 of a desired length that can then be processed with the glass processing apparatus 301. In some embodiments, the glass processing apparatus 301 assists in removing a protective layer from one or more surfaces (e.g., the first major surface 215 and the second major surface 216) of the separated glass ribbon 104. In addition, the glass processing apparatus 301 can assist in collecting the protective layer and processing the protective layer. The processing of the protective layer may comprise several different processes depending on the material of the protective layer. For example, the processing of the protective layer may comprise compressing the protective layer, melting the protective layer, forming one or more melted portions from the protective layer, etc.

In some embodiments, the glass processing apparatus 301 comprises one or more suction devices 303. For example, the glass processing apparatus 301 can comprise a first suction device 305 and a second suction device 307. The first suction device 305 can be positioned to receive a first protective layer 309 from a first glass ribbon 311, which may be similar in structure to the separated glass ribbon 104 of FIGS. 1 and 2. In some embodiments, the first suction device 305 may comprise one or more walls that together form a substantially conical shape and define an opening into which the first protective layer 309 can be received, although other shapes, fore example cylindrical or polyhedron, are contemplated. In some embodiments, the first suction device 305 comprises a first suction hood. In some embodiments, one or more fans may be in fluid communication with the first suction device 305, for example, by being positioned in line with an downstream from the first suction device 305. The one or more fans can generate a negative air pressure within the first suction device 305 to assist in drawing the first protective layer 309 into the first suction device 305.

The first suction device 305 can receive the first protective layer 309 in several ways. In some embodiments, the glass processing apparatus 301 can comprise a blower 313 that is positioned to blow the first protective layer 309 away from the first glass ribbon 311 and toward the first suction device 305 along a first blow path 315. In some embodiments, the blower 313 may comprise a fan with one or more blades that rotate about an axis, a nozzle connected to a source of pressurized air such that the pressurized air may be expelled through the nozzle, or the like. In some embodiments, the blower 313 can generate an airflow along the first blow path 315 that is between the blower 313 and the first suction device 305. In some embodiments, the airflow generated by the blower 313 can be directed in an airflow direction 317 along the first blow path 315 towards the first suction device 305. The blower 313 can be spaced a distance apart from the first suction device 305 such that a gap 319 is defined between the blower 313 and/or first blower path 315 and the first suction device 305 as shown in FIG. 3. In some embodiments, the gap 319 is sized to receive the first glass ribbon 311 (e.g., with the first glass ribbon 311 positioned within the first blow path 315 between the blower 313 and the first suction device 305), such that a size of the gap 319 is larger than a width of the first glass ribbon 311. In some embodiments, the glass ribbon 311 may be placed such that the major surfaces of the glass ribbon 311 are substantially parallel to the first blow path 315 and extend in the direction 317. In further embodiments, the glass ribbon 311 may be positioned in the gap 319 by moving the glass ribbon in a movement direction perpendicular to the direction 317 of the first blow path 315.

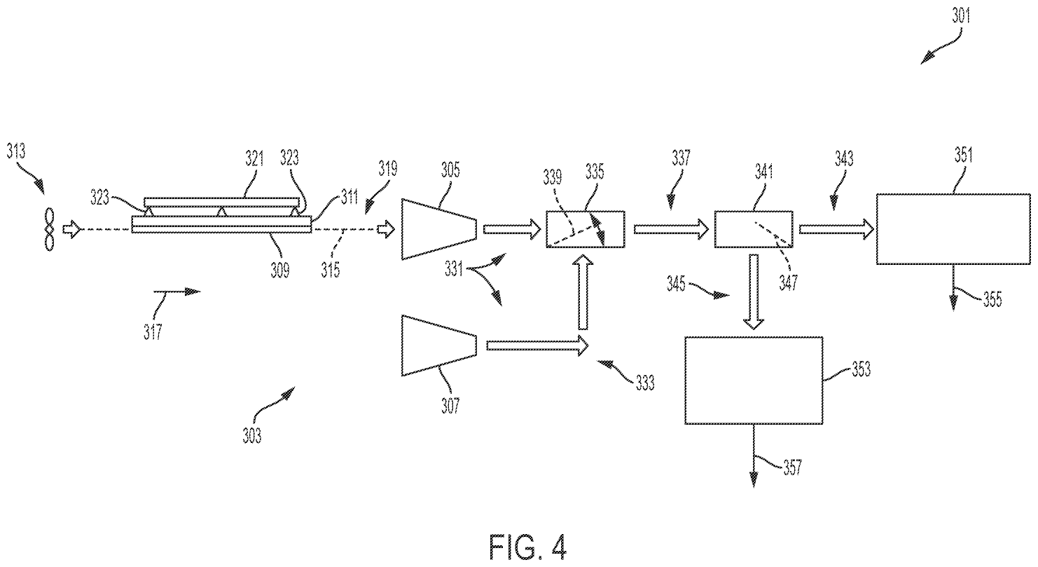

In some embodiments, the glass processing apparatus 301 comprises a robot 321 that is configured to support the first glass ribbon 311 and move the first glass ribbon 311 from a location outside the first blow path 315 to a location within the first blow path 315. For example, the robot 321 may comprise one or more support arms 323 that can engage the first glass ribbon 311. In some embodiments, the one or more support arms 323 comprise suction cups that can engage a major surface (e.g., the first major surface 215 or the second major surface 216) of the first glass ribbon 311. As illustrated in FIG. 3, the robot 321 may support the first glass ribbon 311 outside of the first blow path 315, such that the first glass ribbon 311 does not intersect the first blow path 315 and is not positioned between the blower 313 and the first suction device 305. As will be described relative to FIG. 4, the robot 321 can move the first glass ribbon 311 within the first blow path 315 such that the first glass ribbon 311 is between the blower 313 and the first suction device 305. The glass processing apparatus 301 is not limited to comprising the robot 321 for moving the first glass ribbon 311 into and out of the first blow path 315. For example, in some embodiments, the first glass ribbon 311 may be conveyed by one or more rollers that can roll and cause the first glass ribbon 311 to move into and out of the first blow path 315.

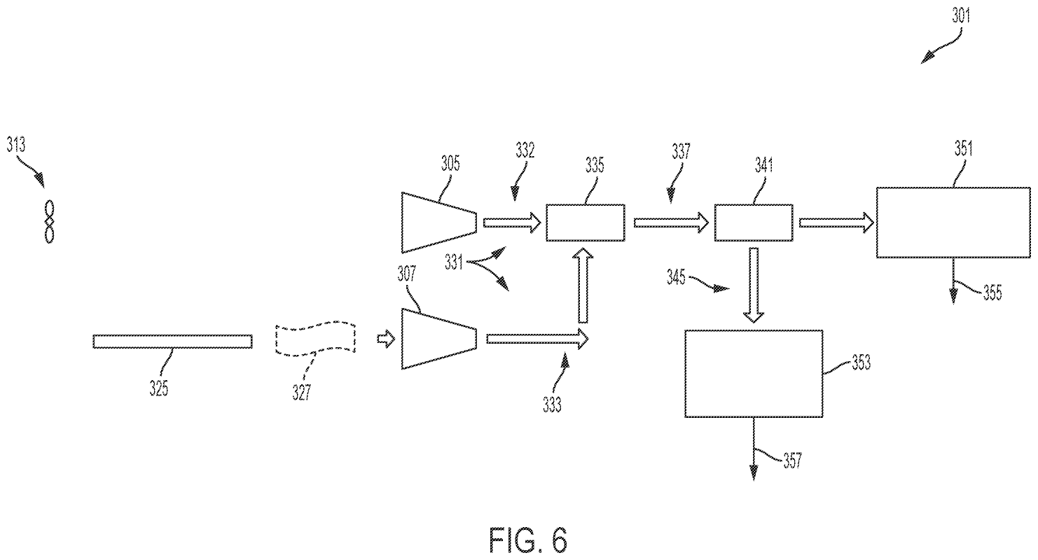

In some embodiments, the second suction device 307 can be positioned to receive from one or more of the first glass ribbon 311 or a second glass ribbon 325 (e.g., illustrated in FIG. 6, wherein the second glass ribbon 325 may be similar in structure to the separated glass ribbon 104 of FIGS. 1 and 2 and the first glass ribbon 311 of FIG. 3) a second protective layer 327 different than the first protective layer 309. For example, the first protective layer 309 and the second protective layer 327 may comprise different materials. In some embodiments, the first protective layer 309 can comprise a polymeric material while the second protective layer 327 comprises a cellulose material. Despite comprising different materials, the first protective layer 309 and the second protective layer 327 can perform similar functions. For example, the first protective layer 309 or the second protective layer 327 can be applied to a major surface (e.g., the first major surface 215 and/or the second major surface 216) of the first glass ribbon 311 or the second glass ribbon 325. The first protective layer 309 or the second protective layer 327 can cover the major surface and reduce the likelihood of unintended damage or contamination to the major surface, for example, by the major surface being scratched and/or unwanted particles accumulating on the major surface.

The second suction device 307 may be similar in some respects to the first suction device 305. For example, the second suction device 307 may comprise one or more walls that together form a substantially conical shape and define an opening into which the second protective layer 327 can be received, although other shapes, for example cylindrical or polyhedron, are contemplated. In some embodiments, the second suction device 327 comprises a second suction hood. In some embodiments, one or more fans may be in fluid communication with the second suction device 307, for example, by being positioned in line with and downstream from the second suction device 307. The one or more fans can generate a negative air pressure within the second suction device 307 to assist in drawing the second protective layer 327 into the second suction device 307. The second suction device 307 can receive the second protective layer 327 in several ways. In some embodiments, the second protective layer 327 can be manually delivered and inserted into the second suction device 307 (e.g., by hand). In some embodiments, the second protective layer 327 can be blown into the second suction device 307, for example, with a blower (e.g., by the same blower 313 or a different blower). In other embodiments, the second protective layer 327 can be delivered to the second suction device 307 by a robot. In some embodiments, the second protective layer 327 can be processed prior to being received within the second suction device 307, for example, by being shredded prior to being received within the second suction device 307.

The glass processing apparatus 301 may comprise one or more ducts 331 that are substantially hollow and through which the first protective layer 309 and the second protective layer 327 can travel. The one or more ducts 331 can be attached to the first suction device 305 and the second suction device 307. For example, a first duct 332 can be attached to a downstream side of the first suction device 305 such that the first duct 332 can receive the first protective layer 309 from the first suction device 305. A second duct 333 can be attached to a downstream side of the second suction device 307 such that the second duct 333 can receive the second protective layer 327 from the second suction device 307. In some embodiments, a hollow joint 335 can join the first duct 332 and the second duct 333. For example, the joint 335 can be positioned downstream from the first suction device 305 and the second suction device 307 such that the joint 335 can receive the first protective layer 309 from the first suction device 305 and the first duct 332, and the second protective layer 327 from the second suction device 307 and the second duct 333. In some embodiments, the joint 335 can comprise a movable baffle 339 that can direct the first protective layer 309 and the second protective layer 327 to the joint duct 337. For example, the baffle 339 can be movable between a first position and a second position. In a first position, the baffle 339 can block the opening between the joint 335 and the second duct 333 while not blocking the opening between the joint 335 and the first duct 332. As such, the first protective layer 309 can pass from the first duct 332, through the joint 335, and to the joint duct 337 while not entering the second duct 333. In a second position, the baffle 339 can block the opening between the joint 335 and the first duct 332 while not blocking the opening between the joint 335 and the second duct 333. As such, the second protective layer 327 can pass from the second duct 333, through the joint 335, and to the joint duct 337 while not entering the first duct 332.

The glass processing apparatus 301 may further comprise a diverting apparatus 341 positioned downstream from the joint 335. In some embodiments, the diverting apparatus 341 is connected to the joint duct 337 opposite the joint 335. As such, the diverting apparatus 341 may be positioned to receive the first protective layer 309 from the first suction device 305 and the second protective layer 327 from the second suction device 307. In some embodiments, the diverting apparatus 341 can be movable to direct the first protective layer 309 along a first travel path 343 and the second protective layer 327 along a second travel path 345. For example, the diverting apparatus 341 can comprise a baffle 347 that may be movable between a first position and a second position. In a first position, the baffle 347 can block the second travel path 345 while not blocking the first travel path 343. As such, the protective layer (e.g., the first protective layer 309) can travel along the first travel path 343. In some embodiments, the baffle 347 can be moved to a second position, in which the baffle 347 can block the first travel path 343 while not blocking the second travel path 345. As such, the protective layer (e.g., the second protective layer 327) can travel along the second travel path 345. The baffle 347 can therefore be moved between the first position and the second position so as to direct the protective layer (e.g., the first protective layer 309 or the second protective layer 327) along the desired travel path (e.g., the first travel path 343 or the second travel path 345). In some embodiments, the diverting apparatus 341 may comprise a valve that can selectively direct the protective layer (e.g., the first protective layer 309 or the second protective layer 327) to a desired location along the first travel path 343 or the second travel path 345.

The glass processing apparatus 301 can comprise one or more processing apparatuses, for example, a first processing apparatus 351 and a second processing apparatus 353. In some embodiments, the first processing apparatus 351 can be positioned to receive the first protective layer 309 from the diverting apparatus 341 and produce a first processed product 355 from the first protective layer 309. In some embodiments, the second processing apparatus 353 can be positioned to receive the second protective layer 327 from the diverting apparatus 341 and produce a second processed product 357 from the second protective layer 327.

Referring to FIG. 4, in some embodiments, methods of processing glass with the glass processing apparatus 301 can comprise positioning the first glass ribbon 311 within the first blow path 315 between the blower 313 and the first suction device 305. For example, the robot 321 may initially support the first glass ribbon 311 at a location that is outside the first blow path 315 (e.g., illustrated in FIG. 3). That is, the first glass ribbon 311 and the first protective layer 309 may not be initially positioned within the gap 319, such that when the first glass ribbon 311 and the first protective layer 309 are outside of the first blow path 315, the first protective layer 309 may not be moved or blown by the blower 313. The first glass ribbon 311 can be moved from the location outside of the first blow path 315 to the location within the first blow path 315 (e.g., illustrated in FIG. 4), for example by the robot 321. For example, the robot 321 can move the first glass ribbon 311 with major surfaces extending in the direction 317 of the first blow path 315 in a direction towards the first blow path 315 and perpendicular to the direction 317 of the first blow path 315. By positioning the first glass ribbon 311 within the first blow path 315 between the blower 313 and the first suction device 305, the first protective layer 309 is also positioned within the first blow path 315 between the blower 313 and the first suction device 305.

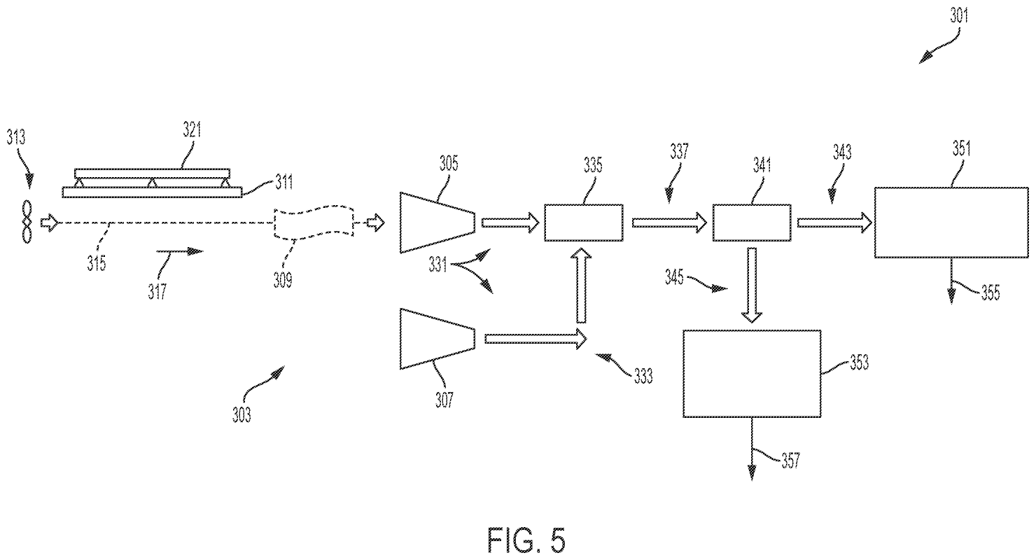

Referring to FIG. 5, in some embodiments, methods of processing glass with the glass processing apparatus 301 can comprise blowing the first protective layer 309 with the blower 313 away from the first glass ribbon 311 along the first blow path 315. For example, methods of processing glass with the glass processing apparatus 301 can comprise blowing the first protective layer 309 from the first glass ribbon 311 to the first suction device 305 along the first blow path 315. With the first glass ribbon 311 and the first protective layer 309 within the first blow path 315, the first protective layer 309 can be removed from the major surface of the first glass ribbon 311 (e.g., by being blown off due to the blower 313) and toward the first suction device 305. In some embodiments, the force of the air from the blower 313 can be sufficient to remove the first protective layer 309 from the first glass ribbon 311 and blow the first protective layer 309 away from the first glass ribbon 311.

In some embodiments, methods of processing glass with the glass processing apparatus 301 can comprise receiving the first protective layer 309 within the first suction device 305. For example, the first blow path 315 from the blower 313 can intersect the first suction device 305. In some embodiments, the opening in the first suction device 305 can be large enough to accommodate for instances when the first protective layer 309 diverges from the first blow path 315. For example, due to the size of the opening in the first suction device 305, even when the first protective layer 309 diverges from the first blow path 315, the first protective layer 309 can still be received within the first suction device 305. To aid in the reception of the first protective layer 309 within the first suction device 305, one or more fans can be positioned in line with and downstream from the first suction device 305 to generate a negative air pressure within the first suction device 305. As such, in addition to the blower 313 blowing air towards the first suction device 305, the first suction device 305 can draw air into the opening of the first suction device 305. Together, the blower 313 and the first suction device 305 can cause the first protective layer 309 to be received within the first suction device 305.

In some embodiments, after the first protective layer 309 has been received within the first suction device 305, methods of processing glass with the glass processing apparatus 301 can comprise diverting the first protective layer 309 from the diverting apparatus 341 to the first processing apparatus 351. For example, the first protective layer 309 can move from the first suction device 305, through the first duct 332, the joint 335, and the joint duct 337 to the diverting apparatus 341. In some embodiments, the baffle 339 of the diverting apparatus 341 can be moved so as to block the second travel path 345. As such, the diverting apparatus 341 can block the first protective layer 309 from inadvertently being diverted to the second processing apparatus 353. Instead, with the baffle 339 blocking the second travel path 345, the diverting apparatus 341 can direct the first protective layer 309 along the first travel path 343 to the first processing apparatus 351. The first processing apparatus 351 can receive the first protective layer 309 and produce the first processed product 355 from the first protective layer 309.

Referring to FIG. 6, in some embodiments, methods of processing glass with the glass processing apparatus 301 can comprise receiving the second protective layer 327 within the second suction device 307. The second protective layer 327 can be provided to the second suction device 307 in several ways. For example, the second protective layer 327 can be manually delivered and inserted into the second suction device 307 (e.g., by hand). In some embodiments, the second protective layer 327 can be delivered to the second suction device 307 by a robot or may be blown into the second suction device 307. To aid the reception of the second protective layer 327 within the second suction device 307, one or more fans can be positioned in line with and downstream from the the second suction device 307 to generate a negative air pressure within the second suction device 307. As such, the second suction device 307 can draw air into the opening of the second suction device 307, which can aid in receiving the second protective layer 327. In some embodiments, the second protective layer 327 can be processed prior to being received within the second suction device 307. For example, the second protective layer 327 can be cut into a plurality of portions prior to being inserted into the second suction device 307. The second protective layer 327 can be cut in several ways, for example, with a shredder that is positioned upstream from the second suction device 307, wherein the shredder can direct the cut second protective layer 327 into the second suction device 307.

In some embodiments, methods of processing glass with the glass processing apparatus 301 can comprise directing the first protective layer 309 from the first suction device 305 to the diverting apparatus 341 and the second protective layer 327 from the second suction device 307 to the diverting apparatus 341. For example, after the first protective layer 309 is received within the first suction device 305, the first protective layer 309 can travel through the first duct 332, the joint 335, and the joint duct 337 to the diverting apparatus 341. In some embodiments, after the second protective layer 327 is received within the second suction device 307, the second protective layer 327 can travel through the second duct 333, the joint 335, and the joint duct 337 to the diverting apparatus 341. In some embodiments, methods of processing glass with the glass processing apparatus 301 can comprise diverting the second protective layer 327 from the diverting apparatus 341 to the second processing apparatus 353. For example, the diverting apparatus 341 can direct the second protective layer 327 along the second travel path 345 to the second processing apparatus 353. The second processing apparatus 353 can receive the second protective layer 327 and produce the second processed product 357 from the second protective layer 327.

In some embodiments, the glass processing apparatus 301 can be set to receive one of the first protective layer 309 or the second protective layer 327. For example, when the glass processing apparatus 301 is set to receive the first protective layer 309, the baffle 347 of the diverting apparatus 341 can be moved to a first position in which the second travel path 345 is blocked while the first travel path 343 is not blocked. As such, the first protective layer 309 can be delivered to the first suction device 305, whereupon the first protective layer 309 can travel through the first duct 332, the joint 335, the joint duct 337, and the diverting apparatus 341. Upon reaching the diverting apparatus 341, the diverting apparatus 341 can direct the first protective layer 309 along the first travel path 343 to the first processing apparatus 351. When the glass processing apparatus 301 is set to receive the second protective layer 327, the baffle 347 of the diverting apparatus 341 can be moved to a second position in which the first travel path 343 is blocked while the second travel path 345 is not blocked. As such, the second protective layer 327 can be delivered to the second suction device 307, whereupon the second protective layer 327 can travel through the second duct 333, the joint 335, the joint duct 337, and the diverting apparatus 341. Upon reaching the diverting apparatus 341, the diverting apparatus 341 can direct the second protective layer 327 along the second travel path 345 to the second processing apparatus 353.

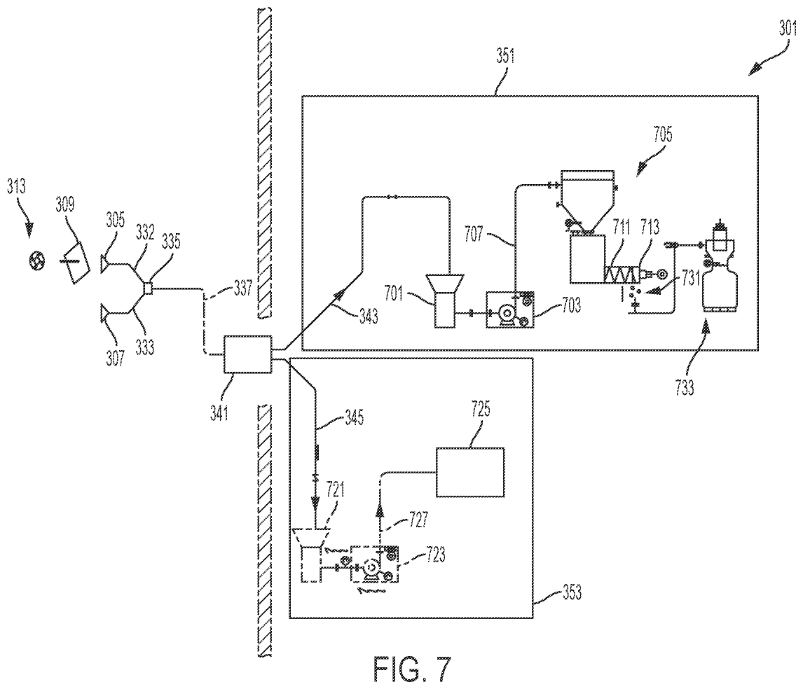

FIG. 7 illustrates a schematic view of an exemplary glass processing apparatus 301 comprising components of the first processing apparatus 351 and the second processing apparatus 353. In some embodiments, the first processing apparatus 351 can comprise a first processing suction device 701. The first processing suction device 701 can be positioned downstream from the diverting apparatus 341 relative to a flow direction of the first protective layer 309. The first processing suction device 701 can be positioned to receive the first protective layer 309 from the diverting apparatus 341. In some embodiments, the first processing suction device 701 can comprise one or more walls that together form a substantially conical shape and define an opening into which the first protective layer 309 can be received, although in further embodiments, other shapes are contemplated, for example cylindrical, polyhedron, etc. In some embodiments, the glass processing apparatus 301 may comprise a plurality of first suction devices 305, such that the first processing suction device 701 can receive first protective layers 309 from a plurality of first suction devices 305. As such, while FIG. 7 illustrates a single diverting apparatus 341 that directs the first protective layer 309 from the first suction device 305 to the first processing suction device 701, in other embodiments, the glass processing apparatus 301 may comprise a plurality of first suction devices 305 and a plurality of diverting apparatuses 341, with the plurality of diverting apparatuses 341 directing the first protective layers 309 to the first processing suction device 701. In some embodiments, the plurality of first suction devices 305 can be fed to a single diverting apparatus 341, whereupon the single diverting apparatus 341 can direct the first protective layers 309 to the first processing suction device 701. In some embodiments, one or more fans can be positioned in line with an downstream from the first processing suction device 701 to generate a negative air pressure within the first processing suction device 701 to assist in drawing the first protective layer 309 into the first processing suction device 701.

In some embodiments, the first processing apparatus 351 can comprise a cutting device 703 that is positioned to receive the first protective layer 309 from the diverting apparatus 341 and cut the first protective layer 309 prior to the first protective layer 309 being received by a first processing station 705 of the first processing apparatus 351. For example, the cutting device 703 can be positioned downstream from the first processing suction device 701 relative to the flow direction of the first protective layer 309. The cutting device 703 comprises one or more blades (e.g., rotational blades, for example) that can cut the first protective layer 309 into a cut material 707 comprising a plurality of portions of the first protective layer 309. In some embodiments, rotation of the rotational blades of the cutting device 703 can not only cut the first protective layer 309 but also generate an airflow to blow the cut material 707 to the first processing station 705. The cutting device 703 can therefore receive the first protective layer 309 from the first processing suction device 701 and deliver the cut material 707 to the first processing station 705.

The first processing station 705 can be positioned downstream from the cutting device 703 relative to a flow direction of the first protective layer 309. In some embodiments, the first processing station 705 of the first processing apparatus 351 can comprise a screw feeder 711 and a melter 713. The screw feeder 711 comprises a screw that can be rotated and powered by a motor. The screw feeder 711 can receive the cut material 707 from the cutting device 703 and, as the screw rotates, the screw feeder 711 can deliver the cut material 707 to a melter 713. The melter 713 can heat the cut material 707 prior to the heated cut material 707 being cut into one or more melted portions 731. In this way, the first processed product 355 can comprise one or more melted portions 731 that may be produced by the first processing station 705. The melted portions 731 can then be delivered to a container 733 for collection.

In some embodiments, methods of processing glass with the glass processing apparatus 301 can comprise cutting the first protective layer 309 (e.g., with the cutting device 703) to produce the cut material 707. For example, the diverting the first protective layer 309 from the diverting apparatus 341 can comprise cutting the first protective layer 309 with the cutting device 703. In some embodiments, the cutting device 703 can comprise one or more rotational blades. As the first protective layer 309 passes through the cutting device 703, the rotational blades of the cutting device 703 can cut the first protective layer 309 into the cut material 707. Following the cutting of the first protective layer 309, methods of processing glass with the glass processing apparatus 301 can comprise directing the cut material 707 (e.g., from the cutting device 703) to the first processing station 705. For example, a duct may extend between the cutting device 703 and the first processing station 705, with the cut material 707 being conveyed from the cutting device 703, through the duct, and to the first processing station 705.

In some embodiments, the second processing apparatus 353 can comprise a second processing suction device 721. The second processing suction device 721 can be positioned downstream from the diverting apparatus 341 relative to a flow direction of the second protective layer 327. The second processing suction device 721 can be positioned to receive the second protective layer 327 from the diverting apparatus 341. In some embodiments, the second processing suction device 721 can comprise one or more walls that together form a substantially conical shape and define an opening into which the second protective layer 327 can be received, although in further embodiments, other shapes are contemplated, for example cylindrical or polyhedron. In some embodiments, the glass processing apparatus 301 can comprise a plurality of second suction devices 307, such that the second processing suction device 721 can receive a plurality of second protective layer 327 from a plurality of second suction devices 307. As such, while FIG. 7 illustrates a single diverting apparatus 341 that directs the second protective layer 327 from the second suction device 307 to the second processing suction device 721, in other embodiments, the glass processing apparatus 301 may comprise a plurality of second suction devices 307 and a plurality of diverting apparatuses 341, with the plurality of diverting apparatuses 341 directing the second protective layers 327 to the second processing suction device 721. In some embodiments, the plurality of second suction devices 307 can be fed to a single diverting apparatus 341, whereupon the single diverting apparatus 341 can direct the second protective layers 327 to the second processing suction device 721. In some embodiments, one or more fans can be positioned in line with and downstream from the second processing suction device 721 to generate a negative air pressure within the second processing suction device 721 to assist in drawing the second protective layer 327 into the second processing suction device 721.

In some embodiments, the second processing apparatus 353 can comprise a second cutting device 723 that is positioned to receive the second protective layer 327 from the diverting apparatus 341 and cut the second protective layer 327 prior to the second protective layer 327 being received by a compressor 725 of the second processing apparatus 353. For example, the second cutting device 723 can be positioned downstream from the second processing suction device 721 relative to the flow direction of the second protective layer 327. The second cutting device 723 can comprise one or more blades (e.g., rotational blades, for example) that can cut the second protective layer 327 into a cut material 727 comprising a plurality of portions of the second protective layer 327. In some embodiments, rotation of the rotational blades of the cutting device 723 can not only cut the second protective layer 327 but also generate an airflow to blow the cut material 727 to the compressor 725. The second cutting device 723 can therefore receive the second protective layer 327 from the second processing suction device 721 and deliver the cut material 727 to the compressor 725. The compressor 725 can be positioned downstream from the second cutting device 723 relative to a flow direction of the second protective layer 327. The compressor 725 can receive and compress the cut material 727, so as to reduce a size of the cut material. In some embodiments, the compressor 725 can comprise a chamber and a piston. The cut material 727 can be received within the chamber, and the piston can compress the cut material 727.

In some embodiments, methods of processing glass with the glass processing apparatus 301 can comprise producing the first processed product 355 from the cut material 707. For example, producing the first processed product 355 can comprise melting the cut material 707 (e.g., generated by cutting the first protective layer 309) and forming a plurality of melted portions from the melted first protective layer 309. In some embodiments, the first processing station 705 can comprise the screw feeder 711 and the melter 713. The screw feeder 711 and the melter 713 can melt the cut material 707 and deliver the melted cut material to a cutting station, whereupon the melted cut material can be cut into the plurality of melted portions. In some embodiments, the plurality of melted portions may comprise pellets, elongated strips of melted material, etc. In some embodiments, methods of processing glass with the glass processing apparatus 301 can comprise compressing (e.g., shrinking, compacting, etc.) the second protective layer 327. For example, the second processing apparatus 353 can comprise a compressor 725. The second protective layer 327 can be directed from the diverting apparatus 341 to the compressor 725, whereupon the second protective layer 327 can be compressed.

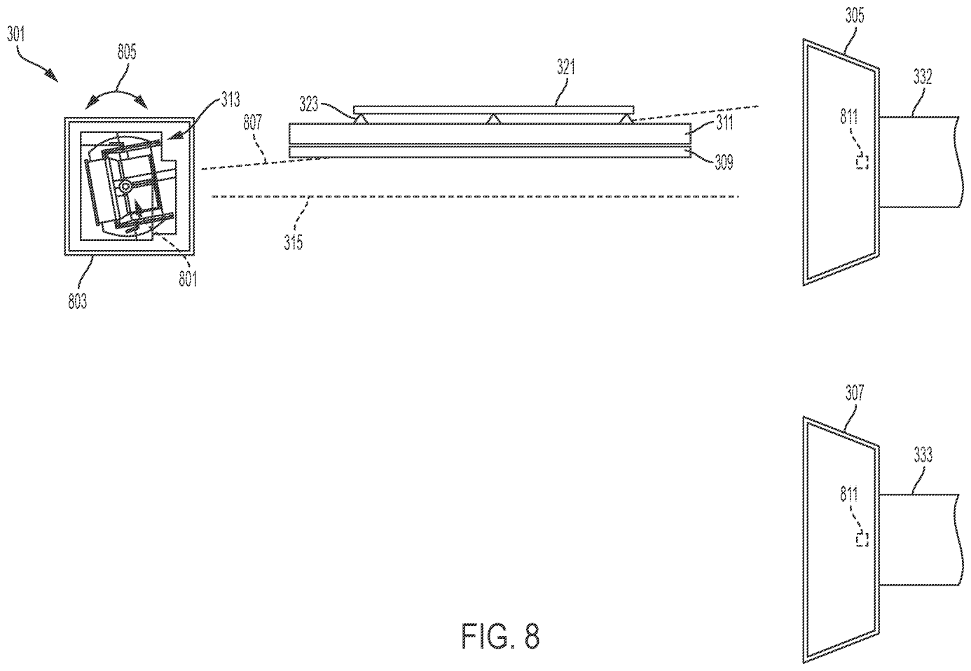

Referring to FIG. 8, a schematic top view of the blower 313, the first suction device 305 and the second suction device 307 are illustrated. In some embodiments, the blower 313 may be rotatable about a blower axis 801. For example, the blower 313 can be attached to a base 803 with a fastener (e.g., a screw, a bolt, etc.). The blower 313 can rotate relative to the base 803 in a rotational direction 805 about the blower axis 801. The blower 313 can be rotated about the blower axis 801 in several ways, for example, by hand (e.g., by an operator manually rotating the blower 313 relative to the base 803), by a robot, etc. In some embodiments, the robot 321 can move the first glass ribbon 311 from the location outside the first blow path 315 (e.g., illustrated in FIG. 3) to the location within the first blow path 315 (e.g., illustrated in FIG. 4). However, in some embodiments, the robot 321 may inadvertently misalign the first glass ribbon 311 relative to the first blow path 315, such that the first glass ribbon 311 may not lie within the first blow path 315. While this misalignment may be inadvertent, the blower 313 may resultingly not blow the first protective layer 309 away from the first glass ribbon 311 and towards the first suction device 305 along the first blow path 315.

To accommodate for these types of misalignment, the blower 313 may be rotatable about the blower axis 801. In some embodiments, methods of processing glass with the glass processing apparatus 301 can comprise rotating the blower 313 to adjust the blower 313 for a position of the first glass ribbon 311 relative to the first suction device 305. For example, when the robot 321 has misaligned the first glass ribbon 311 such that the first glass ribbon 311 does not lie within the first blow path 315, the blower 313 can be rotated, such that the first blow path 315 can be adjusted to an adjusted first blow path 807. In some embodiments, the blower 313 can rotate about the blower axis 801 to a degree in which the first glass ribbon 311 lies within the adjusted first blow path 807. In this way, the adjusted first blow path 807 can intersect the first glass ribbon 311 and the first suction device 305. The blower 313 can then blow the first protective layer 309 away from the first glass ribbon 311 and toward the first suction device 305 along the adjusted first blow path 807.

In some embodiments, the glass processing apparatus 301 can comprise a sensor 811 positioned to detect a presence of one or more of the first protective layer 309 within the first suction device 305 or the second protective layer 327 within the second suction device 307. In some embodiments, the sensor 811 can comprise a wave sensor, for example, a supersonic wave sensor, that can detect the receiving of the first protective layer 309 within the first suction device 305. For example, one sensor 811 can be positioned adjacent to or within the first suction device 305 while another sensor 811 can be positioned adjacent to or within the second protective layer 327. In some embodiments, the sensor 811 can detect a disturbance in the air within the first suction device 305 and the second suction device 307. This disturbance in the air may be indicative of the first protective layer 309 being received within the first suction device 305 or the second protective layer 327 being received within the second suction device 307. In this way, methods of processing glass with the glass processing apparatus 301 can comprise detecting the presence of one or more of the first protective layer 309 within the first suction device 305 or the second protective layer 327 within the second suction device 307. Methods of processing glass with the glass processing apparatus 301 can further comprise detecting the receiving of the first protective layer 309 within the first suction device 305.

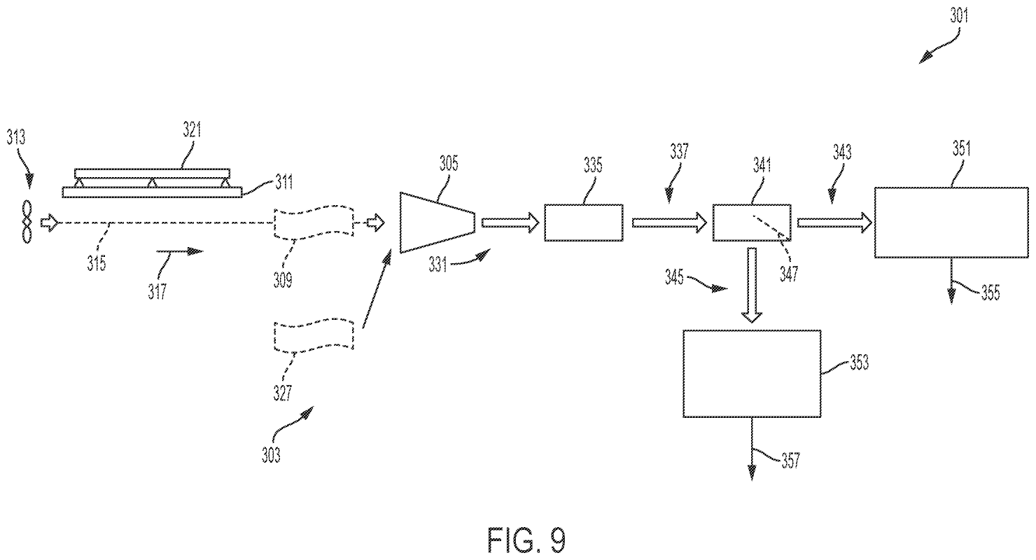

Referring to FIG. 9, the glass processing apparatus 301 is not limited to comprising a plurality of suction devices (e.g., as illustrated in FIGS. 3 to 8 with the first suction device 305 and the second suction device 307). Rather, in some embodiments, the glass processing apparatus 301 can comprise one suction device, for example, the first suction device 305. The first suction device 305 can be positioned to receive one or more of the first protective layer 309 from the first glass ribbon 311 or the second protective layer 327 from one or more of the first glass ribbon 311 or the second glass ribbon 325. For example, in some embodiments, the first suction device 305 can receive the first protective layer 309 from one or more first glass ribbons 311. After a period of time, the first suction device 305 can then receive the second protective layer 327. The second protective layer 327 can be received from one or more of the first glass ribbon 311 or the second glass ribbon 325 in a similar manner as to how the second protective layer 327 is received within the second suction device 307 (e.g., illustrated in FIGS. 3 to 8). When the first suction device 305 receives the first protective layer 309, the baffle 347 can be moved to the first position, such that the baffle 347 can block the second travel path 345 while not blocking the first travel path 343. As such, the first protective layer 309 can travel along the first travel path 343 to the first processing apparatus 351. When the first suction device 305 receives the second protective layer 327, the baffle 347 can be moved to the second position, such that the baffle 347 can block the first travel path 343 while not blocking the second travel path 345. As such, the second protective layer 327 can travel along the second travel path 345 to the second processing apparatus 353. By providing the glass processing apparatus 301 with one suction device (e.g., the first suction device 305), assembly and/or maintenance of the glass processing apparatus 301 may be simplified.

In some embodiments, the glass processing apparatus 301 can provide for improved collection of the first protective layer 309 and the second protective layer 327. For example, by providing the first suction device 305, the first protective layer 309 can be received within the first suction device 305 and directed towards the first processing apparatus 351, whereupon the first protective layer 309 can be processed. Likewise, by providing the second suction device 307, the second protective layer 327, which may comprise a different material than the first protective layer 309, can be received within the second suction device 307 and directed towards the second processing apparatus 353, whereupon the second protective layer 327 can be processed. In this way, the first protective layer 309 and the second protective layer 327 can remain segregated from each other, so as to improve the separate collection of the first protective layer 309 and the second protective layer 327. In addition, by providing the glass processing apparatus 301 with the blower 313, easier and more efficient collection of the first protective layer 309 is facilitated due to the blower 313 blowing the first protective layer 309 into the first suction device 305. In this way, manual handling of the first protective layer 309 and insertion of the first protective layer 309 into the first suction device 305 may be avoided, thus speeding up the collection process. Further, the diverting apparatus 341 helps to receive protective layers from separate sources and/or locations at a single location, and deliver the protective layers to a desired downstream location. As such, the need for multiple diverting apparatuses 341 may be reduced, thus decreasing costs that may be associated with implementing and maintaining a plurality of diverting apparatuses.

Accordingly, the following nonlimiting embodiments are exemplary of the present disclosure.

Embodiment 1. A glass processing apparatus can comprise a first suction device positioned to receive one or more of a first protective layer from a first glass ribbon or a second protective layer from one or more of the first glass ribbon or a second glass ribbon. The second protective layer is different than the first protective layer. The glass processing apparatus can comprise a diverting apparatus positioned to receive the first protective layer and the second protective layer. The diverting apparatus is movable to direct the first protective layer along a first travel path and the second protective layer along a second travel path. The glass processing apparatus can comprise a first processing apparatus positioned to receive the first protective layer from the diverting apparatus and produce a first processed product from the first protective layer. The glass processing apparatus can comprise a second processing apparatus positioned to receive the second protective layer from the diverting apparatus and produce a second processed product different than the first processed product, from the second protective layer.

Embodiment 2. The glass processing apparatus of embodiment 1, further comprising a second suction device positioned to receive from one or more of the first glass ribbon or the second glass ribbon the second protective layer.

Embodiment 3. The glass processing apparatus of any one of embodiments 1-2, further comprising a blower positioned to blow the first protective layer away from the first glass ribbon and toward the first suction device along a first blow path.

Embodiment 4. The glass processing apparatus of any one of embodiments 1-3, wherein the first glass ribbon comprises a separated glass ribbon.

Embodiment 5. The glass processing apparatus of any one of embodiments 2-4, further comprising a sensor positioned to detect a presence of one or more of the first protective layer within the first suction device or the second protective layer within the second suction device.

Embodiment 6. The glass processing apparatus of any one of embodiments 1-5, further comprising a cutting device positioned to receive the first protective layer from the diverting apparatus and cut the first protective layer.

Embodiment 7. The glass processing apparatus of any one of embodiments 1-6, wherein the first processing apparatus comprises a screw feeder and a melter, and the first processed product comprises one or more melted portions.

Embodiment 8. The glass processing apparatus of any one of embodiments 1-7, wherein the second processing apparatus comprises a compressor.

Embodiment 9. The glass processing apparatus of any one of embodiments 1-8, wherein the first protective layer comprises a polymeric material.

Embodiment 10. The glass processing apparatus of any one of embodiments 1-9, wherein the second protective layer comprises a cellulose material.

Embodiment 11. A method of processing glass with a glass processing apparatus can comprise receiving a first protective layer within a first suction device. The method can further comprise receiving a second protective layer within a second suction device. The method can further comprise directing the first protective layer from the first suction device to a diverting apparatus and the second protective layer from the second suction device to the diverting apparatus. The method can further comprise diverting the first protective layer from the diverting apparatus to a first processing apparatus. The method can further comprise diverting the second protective layer from the diverting apparatus to a second processing apparatus.

Embodiment 12. The method of embodiment 11, further comprising melting the first protective layer and forming a plurality of melted portions from the melted first protective layer.

Embodiment 13. The method of any one of embodiments 11-12, further comprising compressing the second protective layer.

Embodiment 14. The method of any one of embodiments 11-13, further comprising blowing the first protective layer away from a first glass ribbon to the first suction device along a first blow path.

Embodiment 15. The method of any one of embodiments 11-14, wherein the diverting the first protective layer from the diverting apparatus comprises cutting the first protective layer.

Embodiment 16. The method of any one of embodiments 11-15, further comprising detecting a presence of one or more of the first protective layer within the first suction device or the second protective layer within the second suction device.

Embodiment 17. A method of processing glass with a glass processing apparatus can comprise positioning a first glass ribbon within a first blow path between a blower and a first suction device. The method can further comprise blowing a first protective layer with the blower away from the first glass ribbon along the first blow path. The method can further comprise receiving the first protective layer within the first suction device. The method can further comprise cutting the first protective layer to produce a cut material. The method can further comprise directing the cut material to a first processing station. The method can further comprise producing a first processed product from the cut material.

Embodiment 18. The method of embodiment 17, wherein the producing the first processed product comprises melting the cut material and forming a plurality of melted portions from the melted cut material.

Embodiment 19. The method of any one of embodiments 17-18, further comprising detecting the receiving of the first protective layer within the first suction device.

Embodiment 20. The method of any one of embodiments 17-19, further comprising rotating the blower to adjust the blower for a position of the first glass ribbon relative to the first suction device.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example within about 5% of each other, or within about 2% of each other.

As used herein, the terms “comprising” and “including,” and variations thereof shall be construed as synonymous and open-ended, unless otherwise indicated.

It should be understood that while various embodiments have been described in detail relative to certain illustrative and specific embodiments thereof, the present disclosure should not be considered limited to such, as numerous modifications and combinations of the disclosed features are possible without departing from the scope of the following claims.

What is claimed is:

1. A glass processing apparatus comprising:
a first suction device positioned to receive one or more of a first protective layer from a first glass ribbon or a second protective layer from one or more of the first glass ribbon or a second glass ribbon, the second protective layer different than the first protective layer;
a diverting apparatus positioned to receive the first protective layer and the second protective layer, the diverting apparatus movable to direct the first protective layer along a first travel path and the second protective layer along a second travel path;
a first processing apparatus positioned to receive the first protective layer from the diverting apparatus and produce a first processed product from the first protective layer; and
a second processing apparatus positioned to receive the second protective layer from the diverting apparatus and produce a second processed product different than the first processed product, from the second protective layer.

2. The glass processing apparatus of claim 1, further comprising a second suction device positioned to receive from one or more of the first glass ribbon or the second glass ribbon the second protective layer.

3. The glass processing apparatus of claim 1, further comprising a blower positioned to blow the first protective layer away from the first glass ribbon and toward the first suction device along a first blow path.

4. The glass processing apparatus of claim 1, wherein the first glass ribbon comprises a separated glass ribbon.

5. The glass processing apparatus of claim 2, further comprising a sensor positioned to detect a presence of one or more of the first protective layer within the first suction device or the second protective layer within the second suction device.

6. The glass processing apparatus of claim 1, further comprising a cutting device positioned to receive the first protective layer from the diverting apparatus and cut the first protective layer.

7. The glass processing apparatus of claim 1, wherein the first processing apparatus comprises a screw feeder and a melter, and the first processed product comprises one or more melted portions.

8. The glass processing apparatus of claim 1, wherein the second processing apparatus comprises a compressor.

9. The glass processing apparatus of claim 1, wherein the first protective layer comprises a polymeric material.

10. The glass processing apparatus of claim 1, wherein the second protective layer comprises a cellulose material.

11. A method of processing glass with a glass processing apparatus comprising:
receiving a first protective layer within a first suction device;
receiving a second protective layer within a second suction device;
directing the first protective layer from the first suction device to a diverting apparatus and the second protective layer from the second suction device to the diverting apparatus;
diverting the first protective layer from the diverting apparatus to a first processing apparatus; and
diverting the second protective layer from the diverting apparatus to a second processing apparatus.

12. The method of claim 11, further comprising melting the first protective layer and forming a plurality of melted portions from the melted first protective layer.

13. The method of claim 11, further comprising compressing the second protective layer.

14. The method of claim 11, further comprising blowing the first protective layer away from a first glass ribbon to the first suction device along a first blow path.

15. The method of claim 11, wherein the diverting the first protective layer from the diverting apparatus comprises cutting the first protective layer.

16. The method of claim 11, further comprising detecting a presence of one or more of the first protective layer within the first suction device or the second protective layer within the second suction device.

17. A method of processing glass with a glass processing apparatus comprising:
positioning a first glass ribbon within a first blow path between a blower and a first suction device;
blowing a first protective layer with the blower away from the first glass ribbon along the first blow path;
receiving the first protective layer within the first suction device;
cutting the first protective layer to produce a cut material;
directing the cut material to a first processing station; and
producing a first processed product from the cut material.

18. The method of claim 17, wherein the producing the first processed product comprises melting the cut material and forming a plurality of melted portions from the melted cut material.

19. The method of claim 17, further comprising detecting the receiving of the first protective layer within the first suction device.

20. The method of claim 17, further comprising rotating the blower to adjust the blower for a position of the first glass ribbon relative to the first suction device.
